(19) United States
(12) Patent Application Publication
(10) Pub. No.: US 2005/0219134 A1
(43) Pub. Date: Oct. 6, 2005

(54) Leaky-wave dual polarized slot type antenna

(76) Inventor: Bankov Sergey, Seoul (KR)

Correspondence Address: MORGAN & FINNEGAN, L.L.P., 3 WORLD FINANCIAL CENTER, NEW YORK, NY, 10281-2101, US

(21) Appl. No.: 10/511,873

(22) PCT Filed: Apr. 16, 2003
(86) PCT No.: PCT/KR03/00768

§ 371 Date: Oct. 18, 2004

(30) Foreign Application Priority Data
Apr. 19, 2002 (KR) 10-2002-0021709

(51) Int. Cl. H01Q 13/10

(52) U.S. Cl. 343/770; 343/700 MS; 343/853

(57) ABSTRACT

Disclosed is a leaky-wave dual polarized slot type antenna, including: first and second feeding circuit sections comprised of N-first strip lines and N-second strip lines with a loop every first period along the X-axis on the first dielectric layer and a second period along the Y-axis, in which the N-first strip lines and the N-second strip lines are parallel to each other being alternate, and each length of Ls1 and Ls2 for the first period satisfies the equation of, first and second multi-channel dividers formed at once and the other sides of the first dielectric layer, to connect the N-first strip lines and the N-second strip lines parallel with each other; and first and second central ports formed in the opposite direction of the cavity, each of the feeding circuit sections being connected to the first and second multi-channel dividers; and first and second slot sections being formed by patterning the second shielding layer, in which M-first and M-second slots are arrayed along the direction of the X-axis and each of the first and second slots forms N-row first and N-row second slot arrays, respectively, which cross the first and second strip lines for each, the first slot and the second slot being orthogonal to each other.

### TECHNICAL FIELD

The present invention relates to a micro stripline feeding slot type planar antenna, more particularly, to a leaky-wave dual polarized slot type antenna, capable of transmitting and receiving orthogonal polarized waves.

### BACKGROUND ART

Radars used in ultra high frequency bands and microwave bands, base station antennas, and antennas for using in satellite communications and satellite broadcasts should have high gains. To have high gains, antennas must have directivity, for example, parabolic antennas.

However, since a parabolic antenna occupies a large surface area for high gain, communication equipment of a base station should be substantially large. Also, surface of the antenna is usually coated with endocrine disrupter containing materials, not to be rusted. As a result, the parabolic antenna causes environment pollution not only when it is used but also when it is disposed.

As an attempt to solve the above problems, radio connection methods for reducing size and weight of communication equipment of a base station, development of power controller and interference controller, terminal, and network system techniques are making active progress. Especially, a planar antenna such as a microstrip line antenna is small, light and thin, so it is very convenient to use and its price is substantially low.

The planar antenna, e.g. microstrip line antenna, is utilized for military communications where mobility and maneuverability are required. High communication equipment such as next generation mobile communication system also uses planar antennas for the same reasons.

However, the microstrip line antenna being currently commercialized has drawbacks in that its frequency bandwidth is very narrow and has a low gain. Moreover, it can transmit/receive a single polarized wave only. Thus, to transmit/receive dual polarized waves, a vertically polarized antenna and a horizontally polarized antenna had to be used together at the same time.

### DISCLOSURE OF INVENTION

It is, therefore, an object of the present invention to provide a leaky-wave dual polarized slot type antenna with a broad frequency bandwidth.

Another object of the present invention is to provide a leaky-wave dual polarized slot type antenna, capable of increasing gain.

Still another object of the present invention is to provide a leaky-wave dual polarized slot type antenna, capable of transmitting/receiving vertically and horizontally polarized waves simultaneously on a same plane.

To achieve the above object, there is a leaky-wave dual polarized slot type antenna, including: a first dielectric layer having a XY plane; first and second feeding circuit sections formed on the top or lower portion of the first dielectric layer, comprising a plurality of first strip lines formed of a first loop with a designated shape from one side of the dielectric layer along the direction of the X-axis at a predetermined first period, and a plurality of second strip lines formed of a second loop with a designated shape from the other side of the dielectric layer along the direction of the X-axis at the predetermined first period, in order to feed electromagnetic waves being inputted; a second dielectric layer formed on the top portion of the first and second feeding circuit sections or the top portion of the first dielectric layer; and a shielding layer formed on the top or lower portion of the second dielectric layer, transmitting electromagnetic waves being fed to the first and/or second feeding circuit sections as vertically polarized waves and/or horizontally polarized waves.

Preferably, the first loop has a sine wave pattern and the second loop has a circular shape.

Preferably, the distance between two arbitrary neighboring first strip lines formed along the direction of the Y-axis as well as the distance between two arbitrary neighboring second strip lines formed along the direction of the Y-axis are constant.

Preferably, the distance between two arbitrary neighboring first loops formed along the direction of the X-axis as well as the distance between two arbitrary neighboring second loops formed along the direction of the X-axis are constant.

The formation period of the first loop formed on each of the first strip lines along the direction of the X-axis is same with the formation period of the second loop formed on each of the second strip lines.

Preferably, the first and second feeding circuit sections are divided by at least one central port of the Y-axis, the ports having designated shapes and lengths, and the first strip lines and the second strip lines are symmetrical or asymmetrical around the ports.

Another aspect of the present invention provides a leaky-wave dual polarized slot type antenna, including: a first dielectric layer having a XY plane; a first feeding circuit sections formed on the top or lower portion of the first dielectric layer, comprising a plurality of first strip lines formed of a first loop with a designated shape from one side of the dielectric layer along the direction of the X-axis at a predetermined first period, in order to feed electromagnetic waves being inputted; a second dielectric layer formed on the top portion of the feeding circuit section; and a first shielding layer formed on the top or lower portion of the second dielectric layer, transmitting electromagnetic waves being fed to the feeding circuit section as vertically polarized waves or horizontally polarized waves.

The antenna further include a third dielectric layer formed on the second shielding layer; a second feeding circuit section formed on the top or lower portion of the third dielectric layer, comprising a plurality of second strip lines formed of a second loop with a designated shape from the other side of the third dielectric layer along the direction of the X-axis, in the opposite direction of the first strip lines formed on the first dielectric layer, at the predetermined first period, in order to feed electromagnetic waves being inputted; a fourth dielectric layer formed on the top portion of the second feeding circuit section; and a second shielding layer formed on the top or lower portion of the fourth dielectric layer, transmitting electromagnetic waves being fed to the second feeding circuit section as vertically polarized waves or horizontally polarized waves.

### BRIEF DESCRIPTION OF DRAWINGS

The above objects, features and advantages of the present invention will become more apparent from the following detailed description when taken in conjunction with the accompanying drawings, in which:

FIG. 1 is a plane view of a leaky-wave dual polarized slot type antenna in accordance with a first preferred embodiment of the present invention;

FIG. 2 is a cross-sectional view of the leaky-wave dual polarized slot type antenna, taken along line a1-a2 of FIG. 1;

FIG. 3a and FIG. 3b are schematic diagrams illustrating opposite radiation directions of main beam according to waves that propagate on a first and second strip line in FIG. 1;

FIG. 4 is a schematic diagram showing non-uniform coupling between a first slot array and a first strip line of FIG. 1;

FIG. 5 graphically depicts a relation between radiation angles (θ) and frequencies (f) in accordance with the first preferred embodiment of the present invention;

FIG. 6 graphically depicts a relation between gains (G) and frequencies (f) in accordance with the first preferred embodiment of the present invention;

FIG. 7 is a diagram showing a state in which a first slot and a second slot are in cross-polarization to each other in accordance with the first preferred embodiment of the present invention;

FIG. 8 is a plane view of a leaky-wave dual polarized slot type antenna in accordance with a second preferred embodiment of the present invention;

FIG. 9 is a plane view of a leaky-wave dual polarized slot type antenna in X s accordance with a third preferred embodiment of the present invention; and

FIGS. 10 and 11 are plane views illustrating a leaky-wave single/dual polarized slot type antenna, respectively, in accordance with a fourth preferred embodiment of the present invention.

### BEST MODE FOR CARRYING OUT THE INVENTION

A preferred embodiment of the present invention will now be described with reference to the accompanying drawings.

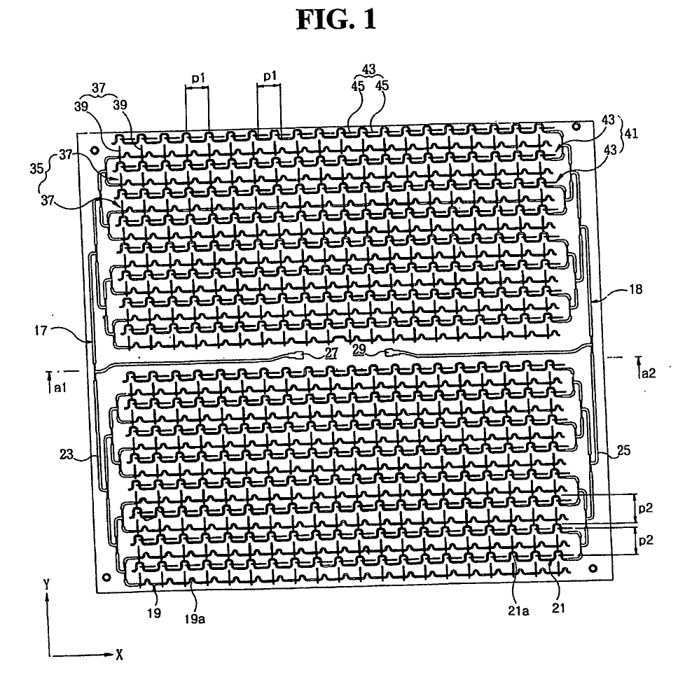

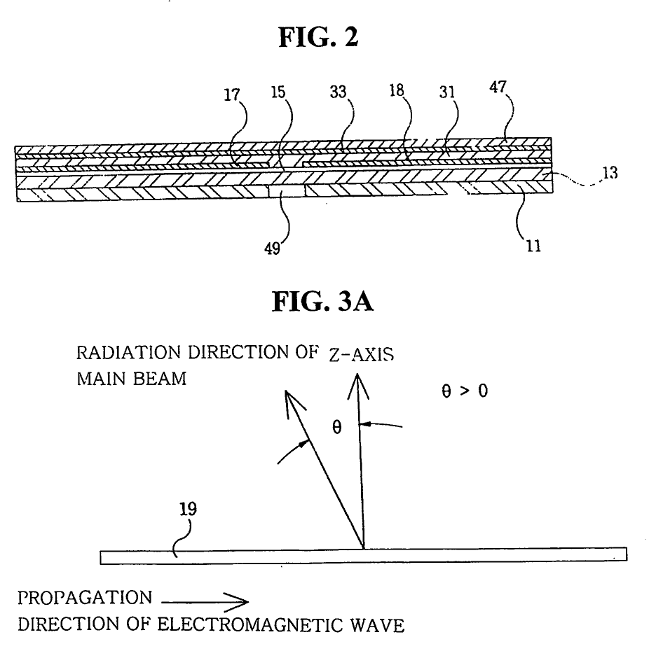

FIG. 1 is a plane view of a leaky-wave dual polarized slot type antenna in accordance with a first preferred embodiment of the present invention, and FIG. 2 is a cross-sectional view of the leaky-wave dual polarized slot type antenna, taken along line a1-a2 of FIG. 1.

Referring to FIG. 1 and FIG. 2, respectively, the leaky-wave dual polarized slot type antenna according to the first preferred embodiment of the present invention includes a first shielding layer 11, a first spacing section 13 disposed on the first shielding layer 11, a first dielectric layer 15 disposed on the first spacing section 13, first and second feeding circuit sections 17 and 18 disposed on the top (or lower) portion of the first dielectric layer 15, a second spacing section 31 disposed on the first and second feeding circuit sections 17 and 18, a second dielectric layer 47 disposed on the second spacing section 31, and a second shielding layer 33 disposed on the lower (or top) portion of the second dielectric layer 47. As depicted in FIG. 1, the second shielding layer 33 consists of first and second slot sections 35 and 41, respectively.

Here, the first shielding layer 11 of FIG. 2 is usually made of conductive metals such as copper, aluminum or silver, and has the shape of a plate in the XY plane, preferably being grounded thereto. The first shielding layer 11 not only supports the elements of the antenna mechanically, but also prohibits the propagating waves along the first and second feeding circuit sections 17 and 18 from radiating to the outside in the direction, i.e.—Z-axis. One or two circular or square cavities 49 are formed at the central portion of the first shielding layer 11. The cavity 49 in FIG. 2, a waveguide, is disposed in the opposite direction of a waveguide of an exciter (not shown) installed at the lower portion of the first shielding layer 11.

In like manner, the second shielding layer 33 formed at the lower (or top) portion of the second dielectric layer 47 is a plate with the XY plane on which conductive materials like copper, aluminum or silver is depositioned or adhered. The second shielding layer 33 not only transmits the electromagnetic waves propagated long the first and second feeding circuit sections 17 and 18 as vertically and horizontally polarized waves but also prohibits the waves from radiating to the outside along the direction of +Z-axis. To be short, the first and second shielding layers 11 and 33 prevents the waves propagated via the first and second feeding circuit sections 17 and 18 from radiating along the Z-axis, thereby preventing the waves from radiating to the outside in the vertical direction of the antenna plane.

The first and second slot sections 35 and 41 are formed by patterning the second shielding layer 33 disposed at the lower (or top) portion of the second dielectric layer 47 using a photolithography method. The first slot section 35 has M×N (M, N are natural numbers) of the first slot 39 in a matrix, being perpendicular to the X-axis, and the second slot section 41 also has M×N of the second slot 45 in a matrix, being orthogonal to M×N of the first slot 39 and parallel to the X-axis. That is, the first slot section 35 is an N-row of the first slot array 37 consisting of M of the first slot 39 being arrayed along the direction of the X-axis, and the second slot section 41 is an N-row of the second slot array 43 consisting of M of the second slot 45 being arrayed in parallel to the X-axis.

As shown in FIG. 1, the first and second slot sections 35 and 41 have a first period P1 along the X-axis, and a second period P2 along the Y-axis.

More specifically, each of the first slot arrays formed along the direction of the X-axis has the identical first period, and each of the second slot arrays formed along the direction of the Y-axis has the identical second period.

Each of the first slot 39 and the second slot 45 receives or transmits vertically and horizontally polarized waves, and has the width W and the length L. The width W and the length L should satisfy the condition of W<L. In addition, the width W of each of the first slot 39 and the second slot 45 should be substantially less than the wavelength (λ) of a wave in free space. That is, the condition W<λ should be satisfied.

The first and second feeding circuit sections 17 and 18 feed electromagnetic waves inputted, and are formed by depositioning or adhering conductive metals like copper, silver or aluminum on the top surface of the first dielectric layer 15 and then patterning with the photolithography method. The first feeding circuit section 17 includes N of first strip line 19 being in parallel to the X-axis, a first multi-channel divider 23 and a first central port 27. The second feeding circuit section 18 includes N of second strip line 21 being in parallel to the first strip line 19, a second multi-channel divider 25 and a second central port 29.

These N first and second strip lines 19 and 21 are formed alternately to each other, and connected in parallel to the first and second multi-channel divider 23 and 25 that are formed on one and the other side of the first dielectric layer 15, respectively. The first and second multi-channel dividers 23 and 25 are respectively connected in parallel to the first and second central ports 27 and 29 at the central portion of the I S antenna. The first and second multi-channel divider 23 and 25 and the first and second central ports 27 and 29 are formed like a shape of strip line.

Each of the second strip line 21 forms a circular second loop 21a every first period P1 along the X-axis, crossing the second slot array 43. Thus, the length Ls2 between two neighboring second slots 45 along the direction of the X-axis of the second strip line 21 is greater than the first period P1 because of the loop. Similarly, each of the first strip line 19 forms a semicircular or sine wave-like first loop 19a every first period P1 along the direction of the X-axis, crossing the first slot array 37. Moreover, the length Ls1 between two neighboring first slots 39 along the direction of the X-axis of the first strip line 19 is greater than the first period P1.

Here, the distance between any two arbitrary neighboring first loops formed along the direction of the X-axis is constant, and in like manner, the distance between any two arbitrary neighboring second loops formed along the direction of the X-axis is constant, as seen in FIG. 1. Also, the formation period of the first loop on each of the first strip line 19 along the X-axis is same with the formation period of the second loop on each of the second strip line 21 along the X-axis.

The first and second strip lines 19 and 21 have a second period P2, respectively, along the direction of the Y-axis. As one can conclude from FIG. 1, the distance between any two neighboring first strip lines formed along the Y-axis is also equal to the distance between any two neighboring second strip lines formed along the Y-axis.

The first and second central ports 27 and 29 in FIG. 1 are disposed inside the cavity 49 of the first shielding layer 11, to be in opposite direction of the waveguide of the exciter. Therefore, when transmitting a signal, the electromagnetic wave is guided through the waveguide, and input to the first and second central ports 27 and 29.

Preferably, the first and second dielectric layers 15 and 47 shown in FIG. 2 are made of materials with dielectric constant is 2-3, such as, polyethylene, compressed polystyrene, polypropylene or Teflon in a film.

The first and second spacing sections 13 and 31 shown in FIG. 2, respectively, separate the first shielding layer 11 from the first dielectric layer 15, and the second shielding layer 33 from the first and second feeding circuit sections 17 and 18. Here, the first and second spacing sections 13 and 31 are formed of materials with dielectric constant of approximately 1, e.g. foam polystyrene, thereby creating an environment similar to free space. In this manner, no dielectric loss caused by the first and second spacing sections 13 and 31 is generated.

The operation principles of the leaky-wave dual polarized slot type antenna according to the first preferred embodiment of the present invention are now explained.

When the exciter generates an electromagnetic wave, the wave is guided to the first and second central ports 27 and 29 through the waveguide, and distributed to the first and second multi-channel dividers 23 and 25, respectively, and finally propagates to the N first and second strip lines 19 and 21. The wave propagates to these N first strip lines 19 and N second strip lines 21 in opposite directions from each other.

The M×N first and second slots 39 and 45 composing the first and second slot sections 35 and 41 polarize and radiate the wave propagated to the N first strip lines 19 and N second strip lines 21 with the vertical and horizontal polarization of each. In other words, when the electromagnetic wave propagates the N first strip lines 19 and N second strip lines 21, an electromagnetic coupling is induced between the M×N first slots 39 and the M×N second slots 45, and the M×N first and second slots 39 and 45 excited by this electromagnetic coupling polarize and radiate the wave in the vertical and horizontal polarization.

The vertically and horizontally polarized waves are radiated from the first and second slot sections 35 and 41, and in order to make the radiation pattern thereof have one single main beam, the periods P1 and P2 should be designated, satisfying the following equations.
P1<λ/(1+sin θ) [Equation 1]
P2<δ [Equation 2]

The angle (θ) in Equation 1 is the angle between the main beam of the radiating wave and the Z-axis. That is, the vertically and horizontally polarized waves from the first and second slot sections 35 and 41 radiate not perpendicularly to the Z-axis, but out of the perpendicular by the angle (θ) from the Z-axis. Since the wave propagates from the first and second strip lines 19 and 21 along the direction of the X-axis, the angle (θ) is also the angle between the X-axis and the Z-axis. Hence, the main beam of the horizontally and vertically polarized waves by the first and second slot sections 35 and 41 is located at the XZ plane.

The waves propagates on the first and second strip lines 19 and 21 in opposite directions from each other. The radiating angle (θ) of the main beam is positive (+) when the angle is relatively reverse against the propagating direction of the wave at an arbitrary strip line, and negative (−) when the angle is relatively forward. Thus, the horizontally and vertically polarized waves of the first and second slot sections 35 and 41 radiate in the same direction and form one main beam.

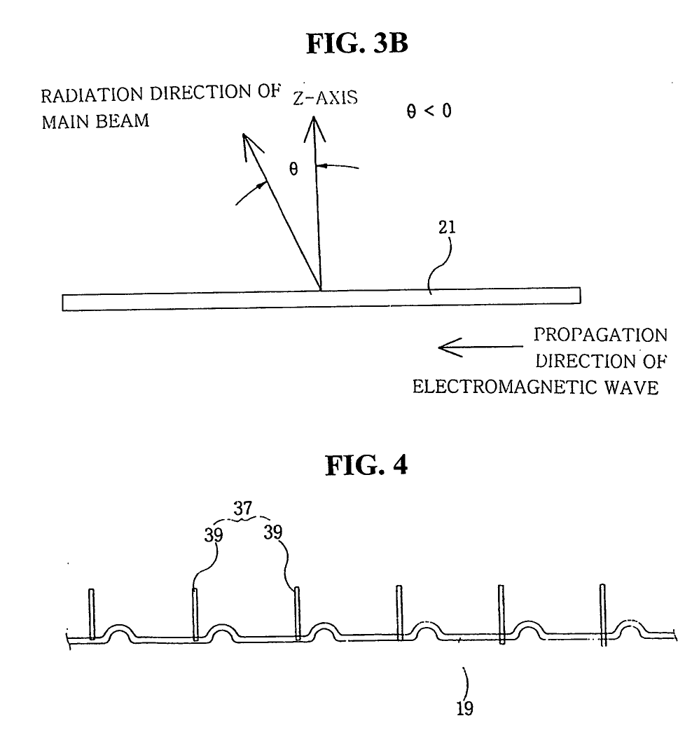

FIG. 3a and FIG. 3b are schematic diagrams illustrating radiating directions of main beam according to waves that propagate to opposite directions on a first and second strip line in FIG. 1. More particularly, FIG. 3a illustrates a case when the radiation angle (θ) of the main beam of the vertically polarized wave is positive (+), i.e. θ>0, as the electromagnetic wave propagates from the left side to the right side at the first strip line 19, and when the main beam of the vertically polarized wave is inclined to the left direction, that is, to the relatively reverse direction of the propagating direction of the wave. Also, FIG. 3b illustrates a case when the radiation angle (θ) of the main beam of the horizontally polarized wave is negative (−) i.e. θ<0, as the electromagnetic wave propagates from the right side to the left side at the second strip line 21, and when the main beam of the horizontally polarized wave is inclined to the left direction, that is to the propagating direction of the wave. The angle (θ) can be expressed as in Equation 3.

$$sin θ = \frac{2 Π}{kP1} - \sqrt{ɛ} \frac{Ls}{P1} \qquad [ Equation 3 ]$$

in which, k is the number of waves in free space, k=2π/δ, and ε is the dielectric constant between the first and second spacing sections 13 and 31. Also, Ls is the length of a strip line between two neighboring slots, and can be substituted by Ls1 and Ls2. Here, the main beam is not perpendicular to the first and second slot sections 35 and 41 and the radiation angle (θ) depends on frequency.

Provided that the radiation angle between the main beam of the horizontally polarized wave and the Z-axis is positive (+), the length Ls1 between two neighboring first slots 39, and the length Ls2 between two neighboring second slots 41 can be expressed by Equation 4 and Equation 5, respectively.

$$\begin{matrix}Ls1 = \frac{P1}{\sqrt{ɛ}} ( \frac{2 Π}{kP1} - sin θ ) & [ Equation 4 ] \\ Ls2 = \frac{P1}{\sqrt{ɛ}} ( \frac{2 Π}{kP1} + sin θ ) & [ Equation 5 ]\end{matrix}$$

Because the main beam of the vertically and horizontally polarized waves is oriented at the same direction, the radiation angle (θ) is same, except that it is distinguished to (+) angles and (−) angles. Based on the lengths Ls1 and Ls2 and the radiation angle expressed in Equations 4 and 5, Equation 6 can be derived as follows.

$$\frac{2 c}{fo} = \sqrt{ɛ} ( Ls1 + Ls2 ) \qquad [ Equation 6 ]$$

Here, c is the velocity of the wave in free space, and fo is an intermediate frequency in the range of operational frequency of the antenna. The lengths Ls1 and Ls2 should be carefully selected to make the main beam of the vertically and horizontally polarized waves orient at the same direction.

Also, the vertically and horizontally polarized waves radiated from the first and second slot sections 35 and 41 have a phase shift (φ) between two neighboring first slots 39 and between two neighboring second slots 45, respectively. The phase shift (φ) can be expressed as Equation 7.
φ=k\sqrt{ε}Ls [Equation 7]

It is important that the vertical waves radiated from each of the first slots 39 of the first slot section 35 have the same phase and thus, the same signal characteristic. In like manner, it is important that the horizontal waves radiated from each of the second slots 41 of the second slot section 45 have the same phase and thus, the same signal characteristic. Therefore, it is preferable that the phase shift (φ) coincides with the phase of the horizontally and vertically polarized waves.

So far, the leaky-wave dual polarized slot type antenna transmits orthogonally polarized waves. But The reception of waves takes place in opposite direction of transmitting waves. Plane waves in free space plane are horizontally and vertically polarized by the M×N first and second slots 39 and 45 of the first and second slot sections 35 and 41, and propagated to the N first and second strip lines 19 and 21 of tile first and second feeding circuit sections 17 and 18. The N first and second strip lines 19 and 21 being alternate with the first and second slot arrays 37 and 43 function as a serial summator of the propagating waves of vertical and horizontal polarization. On the other hand, the first and second multi-channel divider 23 and 25 function as a parallel summator of the vertical and horizontal waves propagated to the N first and second strip lines 19 and 21. Since the first and second multi-channel dividers 23 and 25 function as the parallel summator, each has a wide operational frequency range.

The horizontal and vertical waves summated by the first and second multi-channel dividers 23 and 25 are distributed to the exciter through the first and second central ports 27 and 29.

In general, antenna gain is determined by antenna square and phase-amplitude distribution of an antenna. The phase-amplitude distribution of the antenna in the case of transmitting waves is uniform along the Y-axis by multi-channel dividers. Meanwhile, the phase-amplitude distribution along the X-axis is determined by coupling of the first and second slots 39 and 45 and the first and second strip lines 19 and 21. If the coupling level is constant along the first and second strip lines 19 and 21, the amplitude is determined by X as exponential function. The optimal coupling makes possible the leaky-wave antenna with constant coupling have a maximum gain. The gain loss for optimizing the leaky-wave antenna is about 1 dB.

FIG. 4 is a schematic diagram showing non-uniform coupling between the first a slot array 37 and the first s strip line 19 of FIG. 1.

The coupling level between the first slot array 37 and the first strip line 19 is increased to the propagating direction of the wave on the strip line. At this time, the amplitude along the first strip line 19 is almost uniformly distributed, and thus, the gain loss is reduced. The coupling level between the first slot 39 and the first strip line 19 is dependent on the position of an intersection point. As the intersection point gets closer to the center of the first and second slots 39 and 45, the coupling level is increased. Therefore, when the wave propagates from the left side to the right side in FIG. 4, variable coupling is obtained when each of the first slots 39 of the first slot array 37 has a different intersection point for the first strip line 19.

Overall, the antenna gain can be expressed as Equation 8.

$$G = 10 log ( \frac{4 π}{{λ}^{2}} S cos ( θ ) ) - δ , \qquad [ Equation 8 ]$$

Here, S denotes an antenna's square, and δ denotes gain loss caused by the non-uniform amplitude distribution along the direction of the X-axis. In Equation 8, dissipative loss was ignored. The antenna of constant coupling between the slots and the strip lines has approximately 1 dB of loss (δ), while the optimized antenna of a variable coupling has about 0.5-0.3 dB of loss (δ).

Particularly, resonance property of the first and second slots 39 and 45 is used for increasing the operational frequency range for satellite TV system. The operational frequency range of the antenna is limited primarily because the radiation angle is dependent on the frequency. However, this does not apply to a resonance slot.

When the lengths of the first and second slots 39 and 45 are close to δ/2 (where δ is a free space wavelength) or slightly less than the half wavelength, resonance is generated. The first and second slots 39 and 45 violently disturb wave in the first and second strip lines 19 and 21 at frequencies close to resonance frequency of the first and second slots 39 and 45. Hence, the propagation constant of this wave is extraordinarily dependent on a frequency within the resonance frequency range. This dependence helps one to compensate conventional dependence of angle of radiation on frequency. Radiation angle in some range around resonance frequency of the first and second slots 39 and 45 may be stabilized.

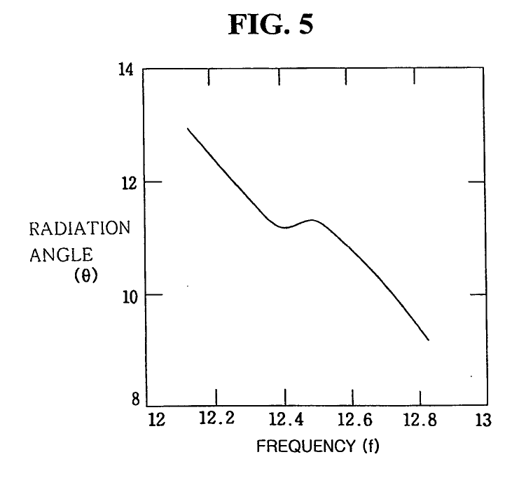

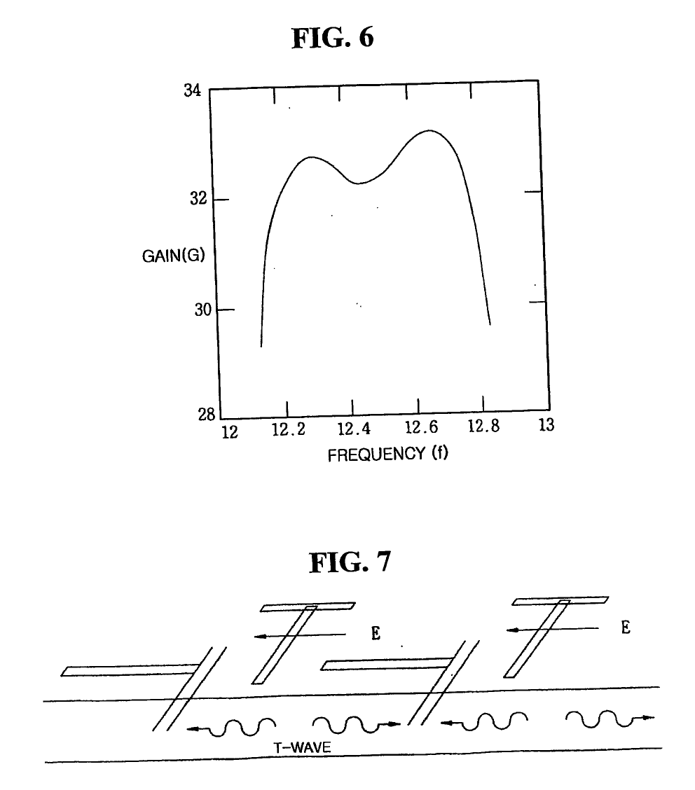

FIG. 5 illustrates the relation between radiation angles (θ) and frequencies (f). As shown in FIG. 5, the radiation angle (θ) changes less than ±1° within the frequency range of 12.2 GHz to 12.75 GHz. Because the change of the radiation angle (θ) is very small, a stable gain can be obtained within the same frequency range. FIG. 6 graphically depicts a relation between gains (G) and frequencies (f). Here, the relative band is about 5%, and this is greater than twice of case of conventional array.

FIG. 7 is a diagram showing a state in which a first slot and a second slot are in cross-polarization to each other.

Different patterns of waves propagates to the first and second feeding sections 17 and 18, such as, effective waves, or called strip line waves propagating while being connected to the first and second strip lines 19 and 21, and parasitic waves, or called T-wave propagating alone without being connected to the first and second strip lines 19 and 21. Here, the T-wave is excited by the first and second slots 39 and 45, and generated between the first and second feeding sections 17 and 18 and the second shielding layer 33, propagating in the horizontal direction. The T-wave is able to carry electromagnetic energy through neighboring slots, without being connected by the first and second strip lines 19 and 21. As a result, the T-wave produce coupling of orthogonal slots of the first and second slots 39 and 45, and increases cross-polarization.

In other words, as shown in FIG. 7, when an electric field of the wave propagating in the first strip line 19 is generated, only the first slot 39 that is perpendicular to the electric field of the wave gets excited. However, the first slot 39 excites not only the effective wave in the first strip line 19 but also the T-wave between the first and second feeding sections 17 and 18 and the second shielding layer 33. The T-wave increases cross-polarization by exciting the second orthogonal slot that has the same amplitude.

To prevent cross-polarization, the second slot 45 orthogonal to the T-wave is disposed symmetrically to the relatively more active first slot 39, and the electric field of the wave is symmetrically distributed around the center of the first slot 39. At this point, the T-wave from the left side and the T-wave from the right side have the same amplitude and have a phase difference of 180°, not exciting the second slot 45.

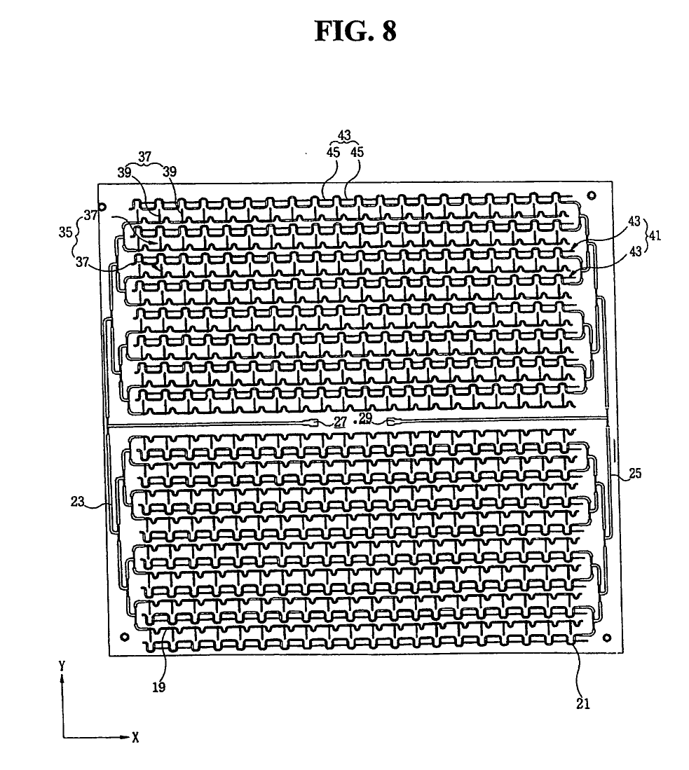

FIG. 8 is a plane view of a leaky-wave dual polarized slot type antenna in accordance with a second preferred embodiment of the present invention.

Referring to FIG. 8, the leaky-wave dual polarized slot type antenna according to the second embodiment is different from that of the first embodiment in that it has different shapes of the N-first and second strip lines 19 and 21 and different shapes of the first and second slot sections 35 and 41. That is, N-first strip lines 19 and N-second strip lines 21 of the leaky-wave dual polarized slot type antenna according to the first embodiment of the present invention are asymmetrically formed around the first and second central ports 27 and 29. However, the first and second strip lines 19 and 21, and the first and second slot sections 35 and 41 of the leaky-wave dual polarized slot type antenna according to the second embodiment of the present invention are divided into halves (N/2) around the first and second central ports 27 and 29, the first and second loops 19a and 21a of each being symmetrical to each other. In addition upper part (or down part) of the second multi channel divider 25 contains a strip line loop that produces 180 deg. phase shift.

In the leaky-wave dual polarized slot type antenna according to the second embodiment of the present invention, the first and second slots 39 and 45 are excited by their crossing slots, namely the second and first slots 45 and 39. However, since the N-first and second strip lines 19 and 21 are divided into halves, i.e. N/2, around the first and second central ports 27 and 19, they have symmetric structures to each other, and the waves of these two symmetric first and second strip lines 19 and 21 are phase-shifted by 180°. These 180° phase-shifted waves compensate each other, and do not propagate to the first and second central ports 27 and 29, consequently reducing a cross-polarization level.

No further details on the operational properties, except for the above properties, of the leaky-wave dual polarized slot type antenna according to the second embodiment of the present invention will be provided here because they are basically identical with the leaky-wave dual polarized slot type antenna according to the first embodiment of the present invention.

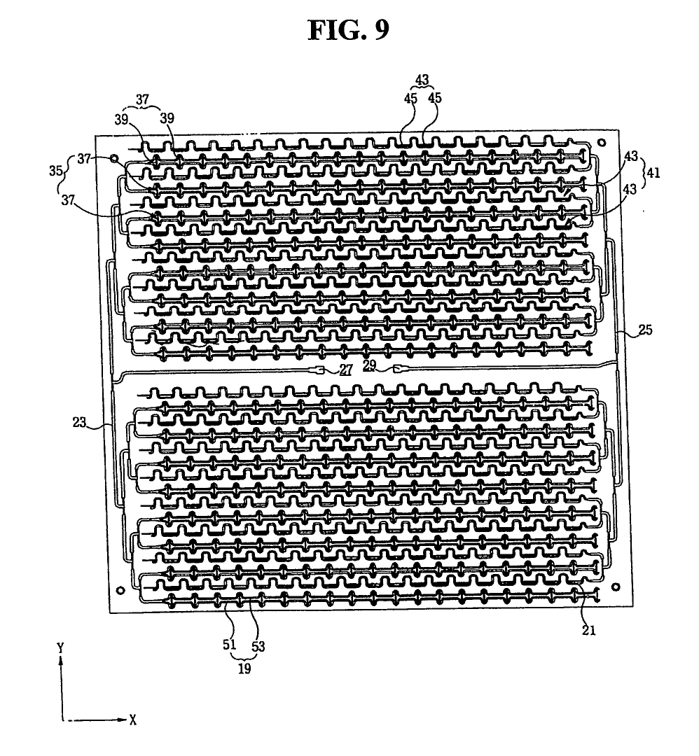

FIG. 9 is a plane view of a leaky-wave dual polarized slot type antenna in accordance with a third preferred embodiment of the present invention.

Referring to FIG. 9, the leaky-wave dual polarized slot type antenna in accordance with the third preferred embodiment of the present invention has different constructions for the first and second slot sections 35 and 41, compared to the first embodiment of the present invention illustrated in FIG. 1. That is, the first strip line 19 includes a first sub-line 51 and a second sub-line 53. The first and second sub-lines 51 and 53 have symmetrical structures from each other, and are formed to cross to both ends of the first slot 39. The second strip line 21 are oriented at one direction.

In the leaky-wave dual polarized slot type antenna in accordance with the third preferred embodiment of the present invention, the first slot 39 is connected to the first sub-line 51 and the second sub-line 53, so the electric field distribution thereof is always symmetrical. As such, even though the second slot 45 might be comparatively symmetrical to the first slot 39, the first slot 39 is not excited by the second slot 45. Hence, the reduction of cross-polarization level is realized more substantially at wide angles of directions.

No further details on the operational properties, except for the above properties, of the leaky-wave dual polarized slot type antenna according to the third embodiment of the present invention will be provided here because they are basically identical with the leaky-wave dual polarized slot type antenna according to the first embodiment of the present invention.

Actually, the leaky-wave dual polarized slot type antenna according to the third embodiment, in which the first strip line 19 is composed of the first and second sub-lines 51 and 53, and the N-second strip lines 21 are divided to N/2 symmetrically around the first and second central ports 27 and 29, as shown in FIG. 8, can be easily derived from the leaky-wave dual polarized slot type antenna according to the first embodiment.

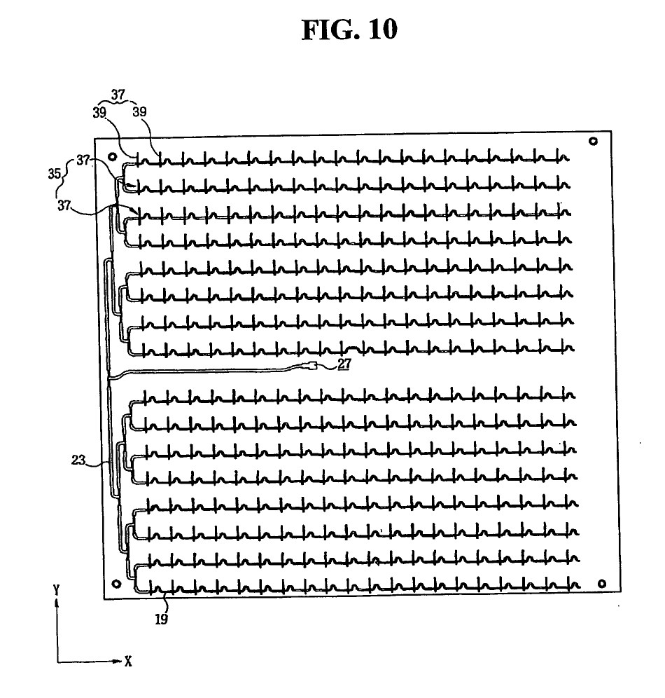

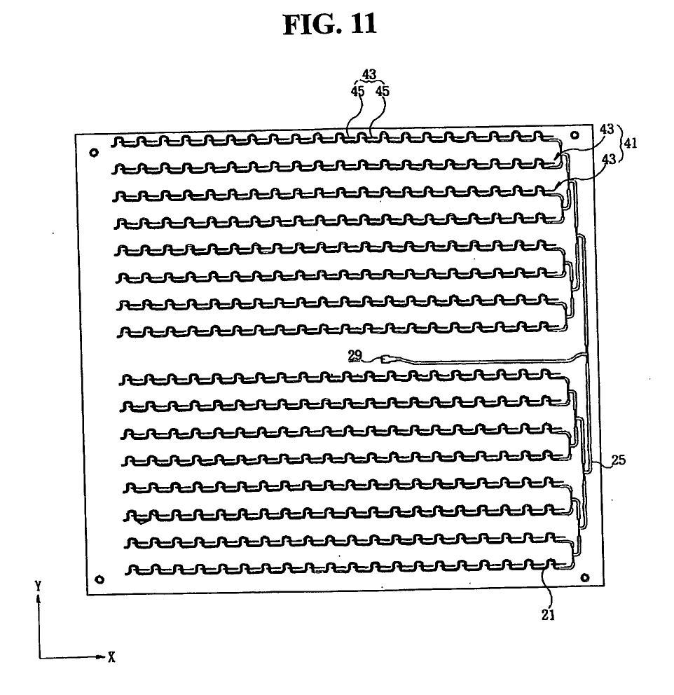

FIGS. 10 and 11 are plane views illustrating a leaky-wave single/dual polarized slot type antenna, respectively, in accordance with a fourth preferred embodiment of the present invention.

Referring to FIGS. 10 and 11, the leaky-wave single/dual polarized slot type antenna, respectively, in accordance with the fourth preferred embodiment of the present invention is distinguished from the leaky-wave dual polarized slot type antenna according to the first embodiment in that there exists separately each of the first and second feeding circuit sections 17 and 18 of FIG. 1 as depicted in FIGS. 10 and 11. Therefore, in order to propagate electromagnetic waves, each of the feeding circuit section in FIG. 10 and FIG. 11 has either each corresponding the first strip line 19 or the second strip line 21, the first strip line 19 having the first loop 19a from one side of the first dielectric layer 15 of FIG. 1 to the direction of the X-axis, and the second strip line 21 having the second loop 21a from the side of the first dielectric layer 15 to the direction of the X-axis.

As such, the second shielding layer 33 of FIG. 1, as illustrated in FIG. 10 and FIG. 11 respectively, is formed at the lower (or top) portion of the second dielectric layer 47 of FIG. 1, in a manner that it induces an electromagnetic coupling with the strip lines formed on either the first slot section 35 or the second slot section 41, thereby horizontally or vertically polarizing electromagnetic waves propagated along the feeding circuit section of FIG. 10 or FIG. 11 and then transmitting the waves.

In short, if the feeding circuit section of FIG. 10 or FIG. 11 is replaced for the first and second feeding circuit sections 17 and 18 of FIG. 1, it can transmit/receive only vertically polarized waves or horizontally polarized waves. However, the construction described in FIG. 1, in which the first and second feeding circuit sections 17 and 18 are separately disposed on the two dielectric layers for transmitting/receiving horizontally and vertically polarized waves, respectively, can be also easily derived.

For example, suppose that the feeding circuit section equipped with the first strip line, and its corresponding shielding layer equipped with the first slot array for receiving and transmitting the vertically polarized waves are used instead of the first and second feeding circuit sections 17 and 18 of FIG. 1. Then a third dielectric layer should be separately formed on the top of the second shielding layer 33 formed at the lower (or top) portion of the second dielectric layer 47, and in order to propagated electromagnetic waves on the top or lower portion of the third dielectric layer, a feeding circuit section including the second strip line, having the second loop from the other side of the third dielectric layer to the X-axis, should be formed in the symmetrical direction of the first strip line of FIG. 1. Also, a fourth dielectric layer should be separately formed on the top of the second feeding circuit section 2, and a third shielding layer including the second slot array for horizontally polarizing and transmitting the electromagnetic waves propagating on the second feeding circuit section should be formed on the lower (or top) portion of the fourth dielectric layer. Here, the positions of the first feeding circuit section and the second feeding circuit section can be switched, and thus the shielding layers thereof should be preferably switched also.

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

The leaky-wave dual polarized slot type antenna of the present invention can be advantageously used since it has a broader frequency bandwidth than the related art, and can increase gain. As a result, the transmission/receiving characteristics of the leaky-wave dual polarized slot type antenna are substantially improved.

Also, the leaky-wave dual polarized slot type antenna can improve basic properties of antennas in that it can simultaneously transmit and receive horizontally and vertically polarized waves being transmitted/received through multi channels on the same plane of an antenna.

1. A leaky-wave dual polarized slot type antenna, comprising:
a first dielectric layer having a XY plane;
first and second feeding circuit sections formed on the top or lower portion of the first dielectric layer, comprising a plurality of first strip lines formed of a first loop with a designated shape from one side of the dielectric layer along the direction of the X-axis at a predetermined first period, and a plurality of second strip lines formed of a second loop with a designated shape from the other side of the dielectric layer along the direction of the X-axis at the predetermined first period, in order to propagate electromagnetic waves;
a second dielectric layer formed on the top portion of the first and second feeding circuit sections or the top portion of the first dielectric layer; and
a shielding layer formed on the top or lower portion of the second dielectric layer, transmitting electromagnetic waves input to the first and/or second feeding circuit sections as vertically polarized waves and/or horizontally polarized waves.

2. The antenna according to claim 1, wherein the first loop has a sine wave shape and the second loop has a circular shape.

3. The antenna according to claim 1, wherein the first strip lines and the second strip lines are formed alternately to each other.

4. The antenna according to claim 1, wherein a distance between two arbitrary neighboring first strip lines formed along the direction of the Y-axis as well as a distance between two arbitrary neighboring second strip lines formed along the direction of the Y-axis are constant.

5. The antenna according to claim 1, wherein the first strip lines are comprised of a pair of first and second sub-lines crossing both ends of the first slot.

6. The antenna according to claim 1, wherein a distance between two arbitrary neighboring first loops formed along the direction of the X-axis as well as a distance between two arbitrary neighboring second loops formed along the direction of the X-axis are constant.

7. The antenna according to claim 6, wherein a predetermined period of the first loop formed on each of the first strip lines along the direction of the X-axis is same with a predetermined period of the second loop formed on each of the second strip lines.

8. The antenna according to claim 1, wherein the first and second feeding circuit sections are divided by more than at least one central port of the Y-axis, the ports having designated shapes and lengths, and the first strip lines and the second strip lines are symmetrical or asymmetrical around the ports.

9. The antenna according to claim 1, wherein the second shield layer comprises:
a first slot section composed of a first slot array with M first slots arrayed along the direction of the X-axis in N rows; and
a second slot section composed of a second slot array with M second slots arrayed along the direction of the X-axis in N rows.

10. The antenna according to claim 9, wherein each of the first slot arrays formed along the X-axis has a first predetermined period to each other, and each of the second slot arrays formed along the Y-axis has a second predetermined period to each other.

11. A leaky-wave dual polarized slot type antenna, comprising:
a first dielectric layer having a XY plane;
a first feeding circuit sections formed on the top or lower portion of the first dielectric layer, comprising a plurality of first strip lines formed of a first loop with a designated shape from one side of the dielectric layer along the direction of the X-axis at a predetermined first period, propagating electromagnetic waves inputted;
a second dielectric layer formed on the top portion of the feeding circuit section; and a first shielding layer formed on the top or lower portion of the second dielectric layer, radiating electromagnetic waves propagating on the feeding circuit section as vertically polarized waves or horizontally polarized waves.

12. The antenna according to claim 11, further comprising:
a third dielectric layer formed on the second shielding layer;
a second feeding circuit section formed on the top or lower portion of the third dielectric layer, comprising a plurality of second strip lines formed of a second loop with a designated shape from the other side of the third dielectric layer along the direction of the X-axis, in the opposite direction of the first strip lines formed on the first dielectric layer, at the predetermined first period, propagating electromagnetic waves inputted;
a fourth dielectric layer formed on the top portion of the second feeding circuit section; and a second shielding layer formed on the top or lower portion of the fourth dielectric layer, radiating electromagnetic waves on the second feeding circuit section as vertically polarized waves or horizontally polarized waves.
